(19) United States
(12) Patent Application Publication
(10) Pub. No.: US 2006/0113296 A1
(43) Pub. Date: Jun. 1, 2006

(54) Flexible electric heating pad

(76) Inventor: Chin-Shen Liang, Tainan Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/999,294

(22) Filed: Nov. 29, 2004

(51) Int. Cl. H05B 3/34

(52) U.S. Cl. 219/528

(57) ABSTRACT

A flexible electric heating pad has a first laminate layer, a second laminate layer, and a printed layer formed on the first laminate layer. The printed layer includes a plurality of distributed conducting wires and a plurality of connected electric resistances. A circuit board is set at a contact point of positive and negative conducting wires of the printed layer. An electric wire connected to the circuit board can be plugged in a power supply terminal. An aluminum foil sheet is sandwiched between the laminate layers on an external exposed side of a surface of the printed layer.

### BACKGROUND OF THE INVENTION

1. Field of the Invention

The invention relates in general to a flexible electric heating pad, and more particularly to a flexible electric heating pad design that can enhance strength of the flexible electric heating pad, achieve a uniform heat conduction, prevent both oxidation and electric shock, and can resist abrasion.

2. Description of the Related Art

Flexible electric heating elements are conventionally used as components of electrothermal equipment. Referring to FIG. 4 and FIG. 5, a flexible electric heating element 3 has a printed layer 31 formed on a lateral surface of a laminate layer 30. The printed layer 31 includes a plurality of conducting wires 32 and a plurality of electric resistances 33. A circuit board 34 is set at a contact point of positive and negative conducting wires 32 of a lateral end of the printed layer 31. An electric wire 35 connected to the circuit board 34 can be plugged in a power supply terminal, so that an electric current can flow along the conducting wires 32, and heat energy can be generated while the electric current flows through the electric resistances 33. A layer of material such as cotton can be spread on a surface of the flexible electric heating element 3, and also the electrothermal products blanket can be manufactured, including products such as an eyeshade, a waistband, and straps according to different shapes and models can be manufactured from the combined cotton and heating element. In addition, the printed layer 31 is printed on the laminate layer 30 so that properties of being soft, flexible, lightweight, comfortable, and foldable are achieved. Thereby the flexible electric heating element 3 can be used to spread on and cover on a specified region of a human body, so as to keep warm or perform a heat treatment remedy on a specified region.

However, this conventional flexible heating pad has the following drawbacks:

The printed circuit is formed on only one side of the plastic material, thereby limiting application of the product.

The printed circuit oxidizes easily due to lack of protection.

The heating element abrades excessively after long-term use.

Heat is not evenly distributed throughout the pad.

The conductive wires break too easily The laminate layer distorts in shape due to excessively high temperatures.

Thus, there is a need to overcome the drawbacks found in the existing flexible electric heating pad.

### SUMMARY OF THE INVENTION

A flexible electric heating pad in accordance with the present invention includes a first layer 10, a glue 20, a first laminate layer 21, an aluminum foil sheet, and a second laminate layer. The first layer 10 comprises a conducting wires 12, electrical resistances 13, and a circuit board 14. In view of the above-mentioned conventional drawbacks, a flexible electric heating pad of the present invention is provided, which can enhance a strength of the flexible electric heating pad, distribute heat conduction evenly, prevent oxidization, avoid electrocution of users, and endure abrasion.

In order to achieve the above-mentioned objectives of structural features and techniques, a flexible electric heating pad of the present invention is provided. The flexible electric heating pad of the present invention is achieved by forming a printed layer on a laminate layer. The printed layer comprises a plurality of distributed conducting wires and a plurality of connected electric resistances. A circuit board is set at a contact point of positive and negative conducting wires of a lateral end of the printed layer. An electric wire connected to the circuit board can be plugged in a power supply terminal. A feature of the present invention lies in that an aluminum foil sheet is configured between the laminate layers on an external exposed side of a surface of the printed layer.

With a design of the flexible electric heating pad of the present invention, the strength of the flexible electric heating pad is enhanced. In addition, the aluminum foil sheet generates an even heat conduction effect. The additional laminate layers of a first laminate layer and a second laminate layer having the aluminum foil sheet sandwiched in-between can be adhered to the external exposed side of the surface of the printed layer, which can prevent oxidation of the printed layer. The external exposed side of the surface of the printed layer also can be hermetically sealed to prevent the risk of electric shock due to the conducting wires of the printed layer becoming exposed, and also the printed layer includes a good effect to endure abrasion. Thereby the flexible electric heating pad is more suitable than the conventional flexible electric heating element to be manufactured into all kinds of shapes and covered with a layer of cotton for use.

### BRIEF DESCRIPTION OF THE DRAWINGS

FIG. 1 shows a perspective exploded view of a flexible electric heating pad in accordance with the present invention.

FIG. 2 shows a perspective view of the flexible electric heating pad of FIG. 1, in an assembled state.

FIG. 3 shows a cross sectional partial view of the flexible electric heating pad of FIG. 1.

FIG. 4 shows a perspective view of a conventional flexible electric heating pad.

FIG. 5 shows a cross sectional partial view of the conventional flexible electric heating pad of FIG. 4.

### DETAILED DESCRIPTION OF THE INVENTION

The flexible electric heating pad of the present invention mainly includes an aluminum foil sheet sandwiched between a first laminate layer and a second laminate layer of a flexible material on an external exposed side of a surface of the printed layer, so as to enhance a strength of the flexible electric heating pad, to conduct heat evenly and prevent oxidation, and further to prevent electric shock and resist abrasion.

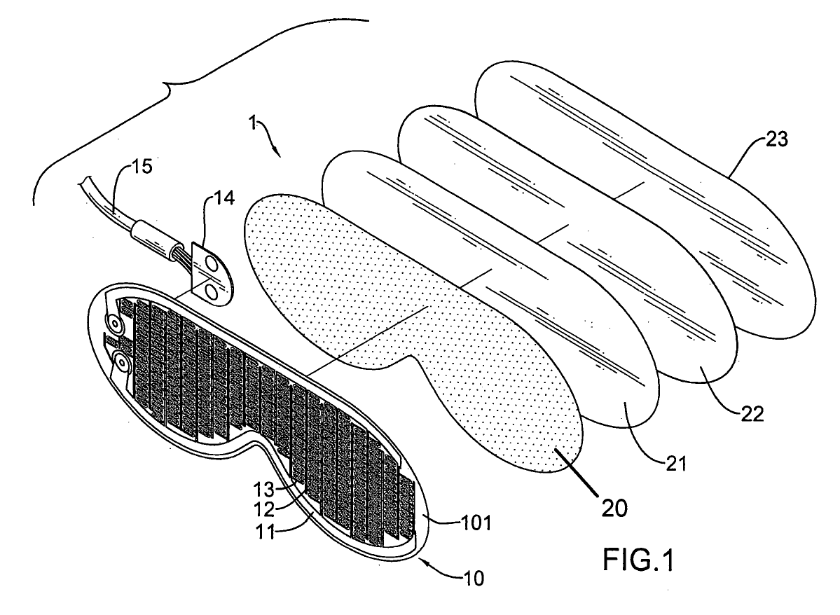

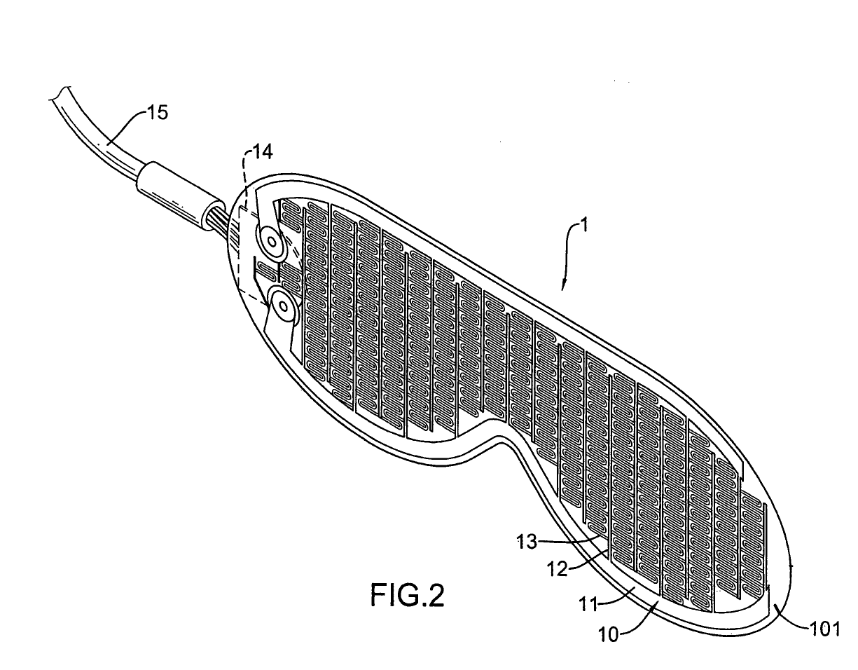

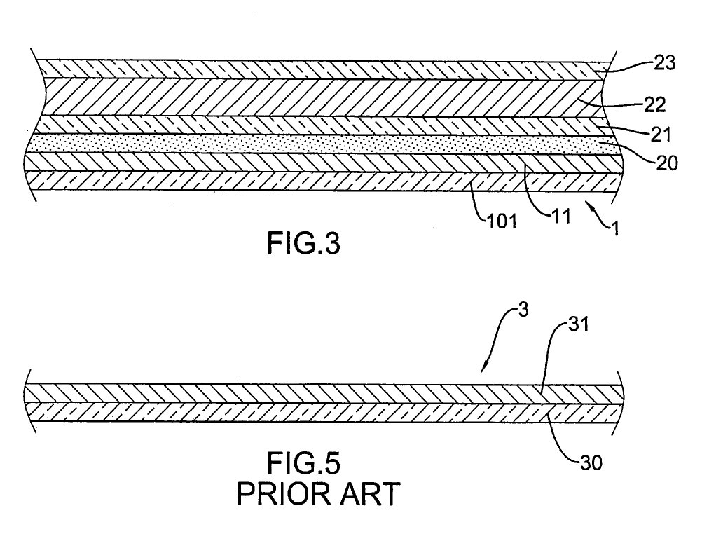

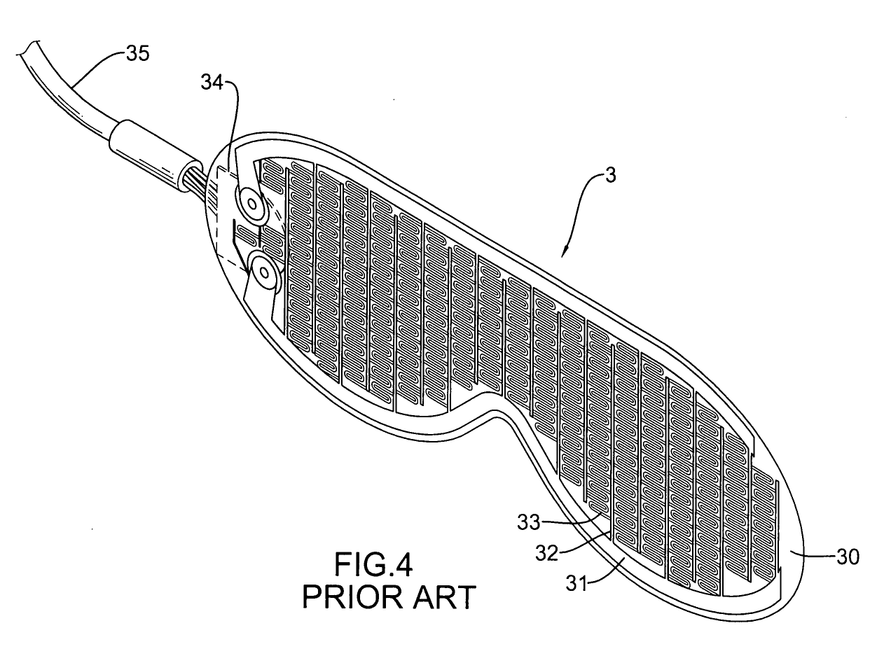

Referring to FIG. 1, FIG. 2 and FIG. 3, a flexible electric heating pad 1 of the present invention pad includes a printed layer 11 on a lateral surface of a first laminate layer 101. The printed layer 11 includes a plurality of distributed conducting wires 12 and a plurality of connected electric resistances 13. A circuit board 14 is set at a contact point of positive and negative conducting wires 12 of a lateral end of the printed layer 11. An electric wire 15 connected to the circuit board 14 can be plugged into a power supply terminal.

A feature of the present invention lies in that an aluminum foil sheet 22 is sandwiched between a first laminate layer 21 and a second laminate layer 23 on an external exposed side of a surface of the printed layer 1. The first and the second laminate layers 21 and 23 having the aluminum foil sheet 22 sandwiched in-between can be adhered to the external exposed side of the surface of the printed layer 11 by using a glue 20, so as to greatly enhance a strength of the flexible electric heating pad 1. Moreover, heat conductivity of the aluminum foil sheet 22 can make the flexible electric heating pad 1 conduct heat evenly. The added laminate layers 21 and 23 that sandwich the aluminum foil sheet 22 can seal the printed layer 1, so as to prevent external exposure oxidation. In addition, the sealed exposed side surface of the printed layer 1 can avoid electric shock from the conducting wires 12, and also can prevent the printed layer 11 suffering abrasion. The aluminum foil sheet 22 causes a fixed configuration of the heating pad such that deformation through exposure to high temperatures in the heating pad are prevented. Thereby the flexible electric heating pad is more suitable than the conventional flexible electric heating element to be manufactured into all kinds of shapes for covering with a layer of cotton. In conclusion, the present invention can enhance strength of the flexible electric heating pad, distribute heat conduction evenly, prevent oxidation, avoid an electric shock and endure abrasion. Therefore, the present invention exactly comprises utility and conforms to novelty non-obviousness and inventive step of requirements of a patent.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A flexible electric heating pad comprising:
a first flat laminate layer made from a plastic material;
a second flat laminate layer made from a plastic material and connected to the first flat laminate layer;
a base flat laminate layer:
a printed layer formed on the base flat laminate layer and connected to an electricity supply, the printed layer comprising a plurality of distributed conducting wires, and a plurality of electrical resistances connected to each other, with the printed layer having an internal side formed on the base flat laminate layer and an external exposed side opposite to the internal side; and
a flat aluminum foil sheet received between the first flat laminate layer and the second flat laminate layer, and the first flat laminate layer adhered to the external exposed side of the printed layer.

2. The flexible electric heating pad as claimed in claim 1, wherein the flat aluminum foil sheet is sandwiched between the first flat laminate layer and the second flat laminate layer with the first flat laminate layer being adhered to the external exposed side of the printed layer by a glue.

3. The flexible electric heating pad as claimed in claim 2, wherein the flat aluminum foil sheet is formed exclusively of aluminum of a thickness to provide a strength preventing deformation through exposure to high temperatures.

4. The flexible electric heating pad as claimed in claim 1, wherein the flat aluminum foil sheet is formed exclusively of aluminum of a thickness to provide a strength preventing deformation through exposure to high temperatures.
